(19) United States
(12) Patent Application Publication
(10) Pub. No.: US 2025/0277166 A1
(43) Pub. Date: Sep. 4, 2025

(54) Unknown

(71) Applicant: BRASIL BIO FUELS S.A, SÃO JOÃO DA BALIZA (BR)

(72) Inventor: Setsuo Sato, Piracicaba (BR)

(21) Appl. No.: 18/596,126

(22) Filed: Mar. 5, 2024

(30) Foreign Application Priority Data
Mar. 1, 2024 (BR) 10 2024 004249 2

(51) Int. Cl. C11C 3/08

(52) U.S. Cl. CPC C11C 3/08

(57) ABSTRACT

The present invention refers to a formulation of fatty materials derivatives with applications such as anti-dust and fluxing in civil construction and paving. The formulation contains monoglycerides, diglycerides, methyl esters of residual fatty acids, palm, palm kernel, soybean, cotton, sunflower, canola, and corn oils.

### FIELD OF THE INVENTION

The present invention refers to a formulation of fatty materials derivatives with applications such as anti-dust and fluxing in civil construction and paving.

In the market to meet these applications, these compounds are normally presented in different formulations with different compositions.

The objective of the present invention was to develop a formulation with multipurpose performance, simplifying manufacturing operations and final applications to reduce logistics and storage costs with the development of a product entirely from renewable sources and with superior performance than conventional formulations.

Traditional anti-dust products are normally derived from petroleum and/or high molecular weight synthetic polymers and most often contain additives such as surfactants, viscosity regulators, coalescents and water.

Fluxing agents are normally petrochemical solvents with a low boiling point (they emit organic vapors) or methyl fatty esters, which are more elaborate products with higher costs than petrochemical solvents.

### BACKGROUND

Dust is unwanted emissions during production, handling, storage, and transportation, composed of very fine particles that result in environmental pollution, generating numerous health problems for workers and residents close to the activities described, whose socio-economic impacts are enormous. Many companies today are focused on resolving or mitigating these unwanted events.

Inorganic substances such as phosphate salts, nitrates, chlorides, sulfates are widely used as fertilizers. Activities related to iron ore whose proportions are gigantic generate dust in a dimension equivalent to this activity. Paving roads generates a huge amount of dust in the initial stage of paving. Unpaved roads generate a huge amount of particulate matter, causing harm to the population, not to mention the erosion process.

Regardless of the nature of the activity, dust is always generated with very fine particles of the order of 5 microns that penetrate the respiratory tracts of living beings causing numerous diseases.

### PRIOR ART

The most classic and oldest method of preventing dust formation is spraying water, but this has a very short effect, less than 5 to 6 hours. In addition to this process increasing soil erosion and consuming a lot of water, this last aspect has been an increasingly critical factor due to climate change.

A technique that emerged over the years was the use of blonde glycerin, but this is completely soluble in water at room temperature and in recent years its price has risen a lot, making its use unfeasible.

Another process that became widely used was the use of products of petrochemical origin, such as distillation residues, oils recovered from ships, compressors, transformers, etc. However, this class of products are not biodegradable and contaminate the soil and the products themselves.

Some examples of patents filed with these objectives are recited below. This is the case of U.S. Pat. No. 7,816,561 filed by Yara Internacional, which uses carbohydrates in solution to avoid dust. Mitsubishi Chem Ind has filed the use of gypsum mixtures with sugar cane molasses in JP56084315.

However, the 2 patents mentioned above have their benefits and weaknesses, such as contamination of the products they are protecting and/or insufficient resistance to bad weather, such as rain and winds of the films formed.

Patent PI 1104018-1 B1 filed by Cargill Inc deals with an aqueous solution composed of a by-product of the production of citric acid and sugar to avoid dust in fertilizers and ore production.

In the case of fluxing agents, most technologies use solvents of petrochemical origin and solvents of vegetable origin, mainly fatty methyl esters. In this case, the fluxing agent has two main functions: to dissolve the bitumen, which is the main component of asphalt, and to provide adequate viscosity so that the bituminous solution can be applied hot or cold.

Patent W02007068461A1 deals with the use of castor oil methyl ester as a fluxing agent, in this case because the carbon chain is hydroxylated, the product becomes self-emussionable, avoiding the need to use surfactants in asphalt formulations.

Patent FR2910477A1 describes a fluxing formulation composed of fatty esters of animal or vegetable origin and a petrochemical solvent with a boiling point below 150° C.

In most cases, the use of compounds that are self-emulsifiable facilitates applications, making formulations more efficient and safer.

### OBJECTIVE OF THE INVENTION

Given the current stage of the 2 techniques mentioned above, the present invention aims to develop formulations with dual function, anti-dust and fluxing, fully biodegradable, guaranteeing the reduction of particulate emissions and/or organic materials in the form of vapor, mainly ensuring the safety of the activities and workers involved.

### BRIEF DESCRIPTION OF THE INVENTION

To avoid the formation of dust that has numerous harmful impacts on the environment, as well as toxic effects, a process was developed based mainly on fatty materials in the form of monoglycerides and diglycerides and fatty methyl esters from residual fatty acids and oil and fat. These compositions are self-emulsifiable in water and, also have self-solvent power in bitumen and other materials of petrochemical origin.

### DETAILED DESCRIPTION OF THE INVENTION

The present invention refers to a formulation containing monoglycerides, diglycerides, methyl esters of residual fatty acids, palm, palm kernel, soybean, cotton, sunflower, canola, and corn oils.

The ratio between glycerides and methyl esters is 90:10, preferably between 40:60.

The formulation may additionally contain other surfactants, such as ethoxylated products, such as fatty alcohols, fatty amines, amphoters, fatty amides, such as alkalonamides.

The formulation may additionally contain solvents, such as light hydrocarbons, acetals, short-chain methyl esters, such as methyl acetate, ethyl acetate, isobutanol, butanol and isoamyl alcohol.

The process of obtaining these formulations is described in the examples below:

### Example 1

a) load 1000 grams of crude palm oil with an acid value lower than 2% oleic acid into a reactor;
b) add 100 grams of 99% purity methanol;
c) add 30 grams of 30% potassium hydroxide solution dissolved in methanol
d) heat to 70° C. and keep under reflux until the combined glycerol stabilizes;
e) apply a vacuum of 600 mmHg pressure to remove residual methanol.

### Analytical Results

Appearance . . . reddish liquid
Mono+Diglycerides . . . 51.4%

Free glycerin . . . 1.2%
Methyl esters . . . 46.8%

### Example 2

a) load 500 grams of residual fatty acid with an acid value of 95% oleic acid into a reactor;
b) add 20 grams of distilled glycerin;
c) add 5 grams of sulfonic acid to toluene
d) heat to 120° C. and maintain under a vacuum of 600 mmHg until the acidity value reaches 3% oleic acidity;
e) cool to 90° C. and add 600 grams of biodiesel produced with palm oil

### Analytical Results

Appearance . . . reddish liquid
Mono+Diglycerides . . . 43.4%
Free glycerin . . . 0.1%.
Methyl esters . . . 55.2%

### Example 3

a) load 500 grams of degummed soybean oil into a reactor;
b) add 50 grams of 99% purity methanol;
c) add 5 grams of toluene sulfonic acid;
d) heat to 120° C. and maintain under a vacuum of 600 mmhg until the acid value reaches 3% oleic acidity;
e) cool to 90° C. and add 600 grams of biodiesel produced with palm oil.

### Analytical Results

Appearance . . . reddish liquid
Mono+Diglycerides . . . 43.4%
Free glycerin . . . 0.1%.
Methyl esters . . . 55.2%

### Application Tests—Anti-Dust

### Example 4

800 liters of water were added to a 1,000-liter isocontainer. At room temperature, 40 kilograms of the product produced according to example 1 were added and the mixture was circulated for 10 minutes in a 2,000 liters per hour circulation pump. After homogenization, the product presented an emulsion appearance of very fine and stable particles without showing separation after 24 hours.

After 24 hours the product was applied to a pile of approximately 100 tons of iron ore.

After 24 hours of application, the formation of dust particles was observed between the pile where the anti-dust was applied and another identical pile without the application. The visual observation was very clear where the pile without application raised a lot of particles and in the pile with application the formation of particles was not observed.

### Example 5

800 liters of water were added to a 1,000-liter isocontainer. At room temperature, 40 kilograms of the product produced according to example 2 were added and the mixture was circulated for 10 minutes in a 2,000 liters per hour circulation pump. After homogenization, the product presented an emulsion appearance of very fine and stable particles without showing separation after 24 hours.

After 24 hours the product was applied to a pile of approximately 100 tons of apatite.

After 24 hours of application, the formation of dust particles was observed between the pile where the anti-dust was applied and another identical pile without the application. The visual observation was very clear where the pile without application raised a lot of particles and in the pile with application no particle formation was observed.

### Application Test—Fluxing Agent

### Example 6

In a reactor with heating and mechanical agitation of 10,000 liters, 2000 kg of material produced according to example 3 was added, the fluxing agent was heated to 120° C., then 1, 500 kg of residual petroleum bitumen was added, the solution was cooled to 80° C., added 175 kilograms of ethoxylated palm kernel oil fatty amine with 12 moles of ethylene oxide. After 1 hour of homogenization, 3500 kilograms of water at 80° C. were added for 30 minutes, the emulsion was kept stirring for 1 hour and after this period the agitation was turned off.

After 24 hours, no separation of the emulsion was observed and the product was applied to a paving area with excellent results, without observing organic emissions and the pavement was cured after 10 hours.

### Example 7

In a 10,000-liter reactor with heating and mechanical agitation, 2000 kilograms of material produced according to example 1 were added, the flux was heated to 120° C., then 1,500 kg of residual petroleum bitumen was added, the solution was cooled to 80° C., added 100 kilograms of ethoxylated palm kernel oil fatty amine with 12 moles of oxide. ethylene After 1 hour of homogenization, 3,500 kilograms of water at 80° C. were added for 30 mins, the emulsion was kept stirring for 1 hour and after this period the agitation was turned off.

After 24 hours, no separation of the emulsion was observed, and the product was applied to a paving area with excellent results without observing organic emissions and the pavement was cured after 15 hours.

1. Formulation characterized in that it contains monoglycerides, diglycerides, methyl esters of residual fatty acids, palm, palm kernel, soy, cotton, sunflower, canola and corn oils.

2. Formulation, according to claim 1, characterized in that the proportion between glycerides and methyl esters is 90:10, preferably between 40:60.

3. Formulation, according to claim 1, characterized in that it may additionally contain other surfactants such as ethoxylated products, preferably fatty alcohols, fatty amines, amphoters, fatty amides, preferably alkalonamides.

4. Formulation, according to claim 1, characterized in that it may additionally contain solvents such as light hydrocarbons, acetals, short-chain methyl esters, preferably methyl acetate, ethyl acetate, isobutanol, butanol and isoamyl alcohol.
